(19) United States
(12) Patent Application Publication
(10) Pub. No.: US 2017/0191307 A1
(43) Pub. Date: Jul. 6, 2017

(54) FIRE RESISTANT GLAZING SCREEN

(71) Applicant: PILKINGTON GROUP LIMITED, LATHOM (GB)

(72) Inventors: STEPHEN IAN BOND, WARRINGTON (GB); FRANK KOERBEL, GLADBECK (DE); CHRISTIAN SEIBT, ESSEN (DE)

(73) Assignee: PILKINGTON GROUP LIMITED, LATHOM (GB)

(21) Appl. No.: 15/314,134

(22) PCT Filed: Jun. 3, 2015
(86) PCT No.: PCT/GB2015/051623

§ 371 Date: Nov. 28, 2016

(30) Foreign Application Priority Data
Jun. 3, 2014 (GB) 1409871.9

(51) Int. Cl. E06B 5/16; E06B 3/60; E06B 3/62

(52) U.S. Cl. CPC E06B 5/165; E06B 3/6202; E06B 3/60

(57) ABSTRACT

A fire resistant glazing screen comprising: at least two monolithic soda lime silica glass panes that are in accordance with the BS EN 572 series standard, wherein said panes are toughened to an extent, wherein each of said panes abuts at least one other of said panes at adjacent edges, and wherein a sealant is located between said adjacent edges of abutting panes.

This invention relates to a fire resistant glazing screen and the use of said fire resistant glazing screen.

Fire resistant glazings include wired glazings and laminated glazings having an interlayer formed of an alkali metal silicate. The transparency of the former may be impaired, with the wiring mounted inside obstructing the view of an observer. The latter may also have impaired transparency, since the intermediate layer can foam up in the event of a fire, becoming opaque. Fire resistant glazings that have undergone a toughening treatment can avoid these problems and may be used in monolithic form.

Known monolithic fire resistant glazing screens include tempered borosilicate glazing screens. These screens may incorporate “butt-joints” whereby neighbouring glass panes abut one another at adjacent edges (i.e. the edges border on one another in close proximity but are not necessarily in direct contact with each other), and a sealing configuration can be installed between these edges. Butt-jointed glazings circumvent the necessity to provide a frame between adjacent panes, thereby improving the aesthetic nature of the glazing screen. Other monolithic fire resistant glazing screens may incorporate toughened soda lime silica glazing screens with fully captured edges (i.e. outer edge regions of panes are housed in a framing system and the adjacent edges of neighbouring panes are located either side of elongated mullions, transoms, muntins and/or profiles over the entirety of said adjacent edges). In the context of the present invention, profiles are substantially thin (e.g. less than 10 cm thick, preferably less than 5 cm thick, even more preferably less than 2 cm thick) sections of a material such as a metal or a polymer that are located between adjacent edges and/or at adjacent edge regions. Some monolithic fire resistant glazing screens may incorporate one or more inlay such as a wire, rod, and/or cord, located between adjacent edges and/or at adjacent edge regions.

In the context of the present invention the term “edge” used in relation to a glass pane is defined as a minor surface of said pane.

In the context of the present invention the term “edge region” used in relation to a glass pane is defined as a minor surface of said pane plus up to a 3 cm width strip of each connecting major surface of said pane, wherein said strip and said minor surface are in direct contact along the entirety of their lengths.

It would be advantageous to provide a monolithic fire resistant glazing screen that exhibits consistently high optical properties and has cost benefits over known borosilicate products. Furthermore it would be desirable to provide a soda lime silica glazing screen that avoids the need for fully captured edges, whilst still providing the necessary fire protection characteristics.

According to a first aspect of the present invention there is provided a fire resistant glazing screen comprising:

at least two monolithic soda lime silica glass panes,

wherein said panes are toughened to an extent,

wherein each of said panes abuts at least one other of said panes at adjacent edges, and

wherein a sealant is located between said adjacent edges of abutting panes.

The inventors of the present invention have surprisingly established that the glazing screen of the first aspect provides sufficient fire resistance performance without necessitating the presence of fully captured edges where adjacent glass panes abut one another. The glazing screen, when tested to either the BS476-20:1987 or BS EN 1363-1:2012 standard temperature/time curve according to the relationship:

T=345 log₁₀(8t+1)+20

where

t is the time from the start of the test in minutes (min);

T is the mean furnace temperature in degrees Celsius (° C.),

can attain a 30 minute fire test rating according to either BS476-22:1987 or BS EN 13501-2:2007 and in some cases also the corresponding 60 minute rating. Furthermore, this glazing screen provides the consistently high optical properties associated with known toughened glazing screens.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

In the context of the present invention the term “sealant” is defined as a substance used to cover one or more surfaces and/or block one or more gaps, to prevent the passage of a liquid or gas and/or to act as an adhesive. Said sealant is typically a liquid or a pliable solid that dries thereby increasing the viscosity of the sealant, sometimes to the extent that it forms a rigid solid.

Preferably the at least two monolithic soda lime silica glass panes are in accordance with the BS EN 572 series standard.

The screen may comprise two, three, four, five or more panes. When the screen comprises three or more panes, at least one of the panes abuts more than one other pane. Said panes may abut at any suitable edge. Said panes may have at least three, preferably four edges.

Preferably a mullion, transom, muntin, profile and/or inlay is not located between at least a section of said adjacent edges and/or is not located at at least a section of adjacent edge regions. Preferably a mullion, transom, muntin, profile and/or inlay is not located between at least 80% of the length of said adjacent edges and/or is not located at at least 80% of the length of adjacent edge regions, more preferably between at least 90% of the length of said adjacent edges and/or at at least 90% of the length of adjacent edge regions, even more preferably between at least 95% of the length of said adjacent edges and/or at at least 95% of the length of adjacent edge regions. Most preferably a mullion, transom, muntin, profile and/or inlay is not located between said adjacent edges and/or is not located at adjacent edge regions. Since the glazing screen of the present invention is able to perform to fire test standards without the presence of fully captured edges between adjacent panes it is simpler, less distracting to an observer and more aesthetically pleasing. The inlay may comprise a wire, rod, and/or cord, located between adjacent edges and/or at adjacent edge regions. Such an inlay may comprise a metal, such as aluminium, and/or a heat resistant material such as asbestos. Preferably said inlay does not comprise a sealant.

Preferably said adjacent edges each comprise two borders that each connects said adjacent edge to a major surface of said pane. Preferably said borders are chamfered such that each border does not form a right angle between the adjacent edge and the major surface of the pane. Preferably said chamfered borders are generally convex. In some embodiments the borders may be asymmetrical. Preferably the borders are symmetrical.

Preferably each adjacent edge further comprises two border regions and a central region, wherein each border region is located adjacent, and preferably along the entire length of, a border and the central region is located between the border regions. Preferably at least one section of the central region is thicker than all of the border regions. The thickness of a particular section of said adjacent edge is understood to mean the length of an imaginary line between the surface of said section and a point that intersects, at a right angle, the imaginary line from the point closest to said section on either of the opposing borders that forms a right angle with its adjacent major surface. Preferably said border regions and/or the central region comprise a generally convex surface. In an alternative embodiment the central region may comprise a generally flat surface. Said generally convex surfaces may comprise one or more curves and/or lines. Said border regions may be symmetrical or asymmetrical. Preferably the border regions are symmetrical.

Preferably at least 50% of the central region (i.e. corresponding to at least 50% of the surface area), more preferably at least 70% of the central region, even more preferably at least 90% of the central region, even more preferably at least 95% of the central region, most preferably all of the central region is thicker than all of the border regions.

Preferably the central region corresponds to at least 50%, more preferably at least 70%, even more preferably at least 80% of the surface area of the adjacent edge.

Preferably said adjacent edges each comprise a generally convex surface. Said generally convex surface may comprise one or more curves and/or lines. Said generally convex surface may be symmetrical or asymmetrical. Preferably said generally convex surface is symmetrical.

Alternatively or additionally, said adjacent edges may comprise one or more indentations and/or protrusions.

Preferably a surface of the adjacent edges has a maximum surface irregularity of 0.1 mm or less, more preferably 0.08 mm or less, even more preferably 0.06 mm or less, most preferably 0.05 mm or less. Preferably said surface of the adjacent edges is a surface of the central region.

Preferably said borders and/or said border regions comprise a surface with a maximum surface irregularity of 0.015 mm or less, more preferably 0.01 mm or less, even more preferably 0.08 mm or less, most preferably 0.07 mm or less. The stress occurring within a glass pane is more likely to be concentrated at border/ridge portions of panes, therefore a smoother surface in these regions provides higher edge strength.

The adjacent edges may have been treated by buffing, heat melting, chemical melting or the like.

The panes may have been toughened by thermal and/or chemical treatments. Preferably said panes and/or said adjacent edges comprise a surface compressive stress of at least 90 MPa, more preferably at least 110 MPa, even more preferably at least 120 MPa, but preferably at most 200 MPa, more preferably at most 180 MPa even more preferably at most 170 MPa.

One or more of the panes may be coated with one or more layers. Said layers may comprise a low emissivity coating. Said layers may coat one or more major surface of one or more of the panes.

The sealant may comprise one or more of silicones, inorganic silicates, acrylics, asphalt, butyl rubber, cement, concrete, epoxy, latex, plastic, polysulfide, polyurethane, and urethane. Preferably the sealant comprises alkali metal silicates, most preferably further comprising inorganic oxides and/or graphite. Preferably the sealant comprises water. These preferred sealants assist in ensuring the integrity of the screen in the event of a fire.

The screen may further comprise one or more point fixings located at the adjacent edges and/or edge regions. In the context of the present invention, point fixings are means for holding said adjacent edges in place wherein the fixing has a longest dimension of at most 10 cm, but preferably at least 1 cm. Such point fixings and/or sealants add rigidity to the screen and help to prevent the panes from moving apart in the event of a fire. Preferably said fixings each comprise two opposing flanges that each contact a major surface of each of the panes adjacent the adjacent edges and straddle a region between said adjacent edges. Said flanges are preferably manufactured from metal. Preferably said flanges are connected via a region between said adjacent edges. Said flanges may be connected by a connection means such as a screw, pin, bolt or any other suitable means. The connection means may be located inside a bushing, preferably a threaded bushing, located between the adjacent edges. Preferably the flanges each comprise a generally flat surface that contacts the major surfaces of the panes. Said generally flat surface may comprise a gasket, e.g. a silicone, mineral fibre (e.g. ceramic wool, fibreglass) or plastic polymer (such as polychlorotrifluoroethylene) gasket. Preferably the flanges are circular, but may be any suitable alternative shape such as square, rectangular, hexagonal, oval etc. Preferably the fixings are spaced at regular intervals along the adjacent edges. Preferably the screen comprises no point fixings. This arrangement is simpler, less distracting and more aesthetically desirable.

Preferably the distance between the closest points of the adjacent edges is at least 3 mm, more preferably at least 4 mm, even more preferably at least 5 mm, but preferably at most 10 mm, more preferably at most 8 mm, even more preferably at most 7 mm. These preferred distances help ensure sufficient integrity and minimum distraction to an ob server.

Preferably the panes each have a thickness of at least 6 mm, preferably at least 8 mm, even more preferably at least 10 mm, most preferably at least 12 mm, but preferably at most 20 mm, more preferably at most 17 mm, even more preferably at most 15 mm.

Preferably the screen further comprises an outer surrounding frame. Said frame may be manufactured from metal or any other suitable material. The screen may further comprise a glazing gasket, sealant, mastic, and/or known glazing materials located at an interface between the panes and the frame.

According to a second aspect of the present invention there is provided the use of a fire resistant glazing screen according to the first aspect of the present invention to prevent the spread of fire.

Preferably said use is in partitions, walls or doors.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawings in which:

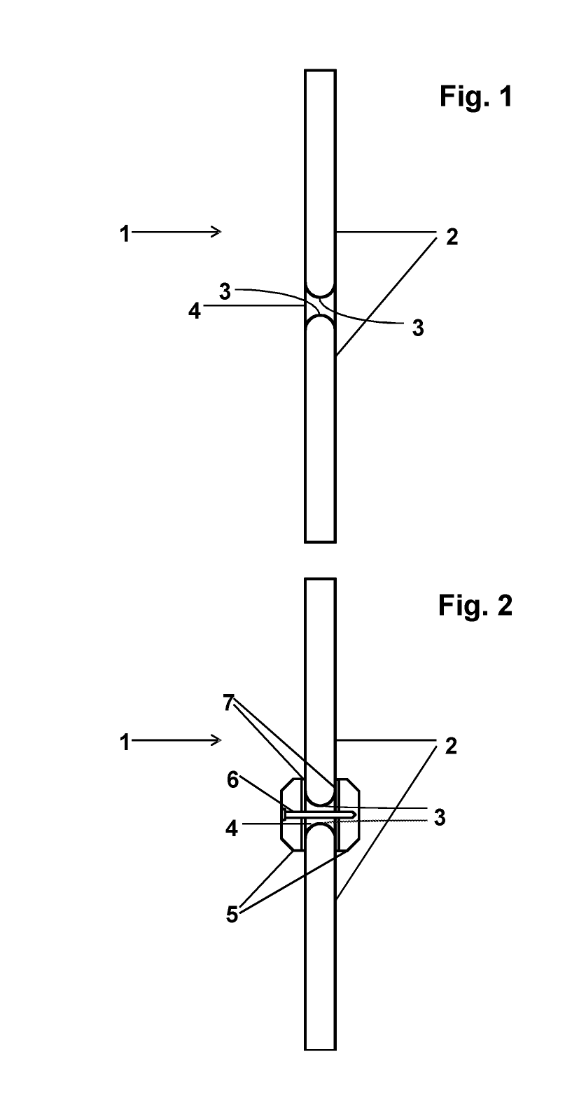

FIG. 1 shows a cross section of a first embodiment of a fire resistant glazing screen in accordance with the present invention; and

FIG. 2 shows a cross section of a second embodiment of a fire resistant glazing screen in accordance with the present invention that incorporates a point fixing.

FIG. 1 shows a cross section of a first embodiment of a fire resistant glazing screen 1 in accordance with the present invention comprising two monolithic soda lime silica glass panes 2 that are in accordance with the BS EN 572 series standard and which have been toughened to an extent. The panes 2 abut one another at adjacent convex edges 3 and a sealant 4 is located between said adjacent edges 3.

FIG. 2 shows a cross section of a second embodiment of a fire resistant glazing screen 1 in accordance with the present invention. This screen 1 has the same components as screen 1 shown in FIG. 1 but additionally comprises button shaped steel point fixings 5 connected via countersunk steel screw 6. Fixings 5 each have a generally flat bottom surface that incorporates a mineral fibre gasket 7. Gaskets 7 each contact a major surface of each of the panes 2 adjacent the adjacent edges 3 and straddle a region between said adjacent edges 3.

### EXAMPLES

A number of glazing screens were tested in accordance with the fire test standard BS EN 1363-1, specifically BS EN 1364-1:1999—Fire resistance tests for non load bearing elements—Part 1: Walls. Each screen comprised three panes of Pilkington Pyroclear (RTM) glass (pane dimensions: 10 mm thick, height 2.87 m and various widths to provide a total width of 3 m) and a sealant between the adjacent edges of the panes. The distance between the closest points of the adjacent edges was 5 mm for each screen. In the case of the screens of examples 2-5, point fixings were located at the adjacent edge regions of the panes at 0.6 m intervals. The point fixings each comprised two circular steel flanges (diameter 35 mm) with mineral fibre gaskets. Each pair of flanges was connected with a countersunk steel screw. The screens of examples 1 and 6 did not incorporate point fixings.

TABLE 1
Fire test results for glazing screens according to the present invention
tested in accordance with the fire test standard BS EN 1363-1,
specifically BS EN 1364-1: 1999.

| Example | Sealant | Point fixings | Result |
|---|---|---|---|
| 1 | Sealmaster (RTM) | x | <30 mins |
| | Fireglaze | | |
| 2 | Sealmaster (RTM) | √ | >30 mins |
| | Fireglaze | | |
| 3 | Kerafix (RTM) | √ | >30 mins |
| | Firestopping Silicone | | |
| 4 | Kerafix (RTM) | √ | >30 mins |
| | Firestop putty | | |
| 5 | Alkali metal silicate | √ | >60 mins |
| 6 | Alkali metal silicate | x | >30 mins |

The screen of Example 1 used the Sealmaster (RTM) Fireglaze sealant, without point fixings. This screen displayed fire resistance but did not achieve 30 minutes to the above standard. The screens of examples 2-4 all incorporated point fixings and exhibited greater than 30 minutes fire resistance to the above standard. The screen of example 5 utilised an alkali metal silicate sealant with point fixings and achieved over 60 minutes to the above standard. The screen of example 6 also used an alkali metal silicate sealant but did not incorporate point fixings and still achieved over 30 minutes to the above standard.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1.-22. (canceled)

23. A fire resistant glazing screen comprising:
at least two monolithic soda lime silica glass panes,
wherein said panes are toughened to an extent,
wherein each of said panes abuts at least one other of said panes at adjacent edges, and
wherein a sealant is located between said adjacent edges of abutting panes.

24. The screen according to claim 23, wherein a mullion, transom, muntin, profile and/or inlay is not located between at least a section of said adjacent edges and/or is not located at least a section of adjacent edge regions.

25. The screen according to claim 23, wherein a mullion, transom, muntin, profile and/or inlay is not located between at least 80% of the length of said adjacent edges and/or is not located at at least 80% of the length of adjacent edge regions.

26. The screen according to claim 23, wherein a mullion, transom, muntin, profile and/or inlay is not located between said adjacent edges and/or is not located at adjacent edge regions.

27. The screen according to claim 23, wherein said adjacent edges each comprise two borders that each connects said adjacent edge to a major surface of said pane.

28. The screen according to claim 27, wherein said borders are chamfered such that each border does not form a right angle between the adjacent edge and the major surface of the pane.

29. The screen according to claim 28, wherein said chamfered borders are generally convex.

30. The screen according to claim 27, wherein each adjacent edge further comprises two border regions and a central region, wherein each border region is located adjacent a border and the central region is located between the border regions, and wherein at least one section of the central region is thicker than all of the border regions.

31. The screen according to 27, wherein each adjacent edge further comprises two border regions and a central region, wherein each border region is located adjacent, and along the entire length of, a border and the central region is located between the border regions, and wherein at least one section of the central region is thicker than all of the border regions.

32. The screen according to claim 30, wherein said border regions and/or the central region comprise a generally convex surface.

33. The screen according to claim 30, wherein the central region comprises a generally flat surface.

34. The screen according to claim 23, wherein said adjacent edges each comprise a generally convex surface.

35. The screen according to claim 27, wherein said borders, border regions or generally convex surface are symmetrical.

36. The screen according to claim 23, wherein said adjacent edges comprise one or more indentations and/or protrusions.

37. The screen according to claim 23, wherein said panes and/or said adjacent edges comprise a surface compressive stress of at least 90 MPa, but at most 200 MPa.

38. The screen according to claim 23, wherein the sealant comprises alkali metal silicates.

39. The screen according to claim 38, wherein the sealant further comprises inorganic oxides and/or graphite.

40. The screen according to claim 23, wherein the screen further comprises one or more point fixings located at the adjacent edges and/or edge regions.

41. The screen according to claim 23, wherein the screen comprises no point fixings.

42. The screen according to claim 23, wherein the distance between the closest points of the adjacent edges is at least 3 mm, but at most 10 mm.

43. The screen according to claim 23, wherein the panes each have a thickness of at least 6 mm, but at most 20 mm.
